(19) United States
(12) Patent Application Publication
(10) Pub. No.: US 2012/0046966 A1
(43) Pub. Date: Feb. 23, 2012

(54) Health Management Application Development and Deployment Framework

(75) Inventors: Hung-Yang Chang, Scarsdale, NY (US); Chia-Fang Chung, Taipei (TW); Pei-Yun Sabrina Hsueh, Hawthorne, NY (US); Tsung-Chi Huang, Taipei (TW); Liangzhao Zeng, Mohegan Lake, NY (US)

(73) Assignee: International Business Machines Corporation, Armonk, NY (US)

(21) Appl. No.: 12/859,617

(22) Filed: Aug. 19, 2010

(51) Int. Cl. G06Q 50/00; G06Q 10/00

(52) U.S. Cl. 705/3

(57) ABSTRACT

Techniques are disclosed for developing health management applications and managing health issues associated with one or more individuals or subjects. For example, a health management system includes the following modules. A health data transformation and routing module converts raw health data to at least one common format and routes the common format health data to one or more other modules that at least one of process and store the common format health data. A health monitoring module receives at least a portion of the common format health data, processes the received data, and provides one or more notifications based on processing results. A health analytics module receives data from one or more other modules and generates health knowledge based on the received data. A health data and knowledge storage module stores data from one or more other modules. Each of the health data transformation and routing module, the health monitoring module, and the health analytics module include one or more application programming interfaces for use in at least one of adding and editing logic associated with the respective module.

### FIELD OF THE INVENTION

The present invention relates generally to information processing systems, and more particularly to techniques for employing such information processing systems to develop health management applications and manage health issues associated with one or more individuals or subjects.

### BACKGROUND OF THE INVENTION

Health management, or more specifically, “wellness management,” aims to manage a person's lifestyle and is key for preventive care and chronic disease treatments that help a person maintain and improve his/her health. For example, the cornerstone of Type II diabetes treatment includes lifestyle modification, exercise and weight management, which can be facilitated and enhanced by wellness management applications. Wellness management applications are software programs that are executed on one or more computing systems that assist users with health management.

With the recent advances in personal wellness monitoring devices and living sensors, wellness management applications are now well-positioned to provide awareness on wellness status and treatment progress, generate alerts of potential risk, and make suggestions on how to maintain and improve a healthy lifestyle. Specifically, these applications are developed based on collected information about vital signs (e.g., heart rate, blood pressure), nutrition, physical exercise, and living environments. It is considered as an efficient and low cost solution for improving healthcare quality.

### SUMMARY OF THE INVENTION

Illustrative principles of the invention provide techniques for developing health management applications and managing health issues associated with one or more individuals or subjects. Accordingly, illustrative principles of the invention provide a health management application development and deployment framework.

For example, in one aspect of the invention, a health management system includes the following modules. A health data transformation and routing module converts raw health data to at least one common format and routes the common format health data to one or more other modules that at least one of process and store the common format health data. A health monitoring module receives at least a portion of the common format health data, processes the received data, and provides one or more notifications based on processing results. A health analytics module receives data from one or more other modules and generates health knowledge based on the received data. A health data and knowledge storage module stores data from one or more other modules. Each of the health data transformation and routing module, the health monitoring module, and the health analytics module include one or more application programming interfaces for use in at least one of adding and editing logic associated with the respective module.

In one or more embodiments, the system may also include a health management interface for providing at least one end user access to data at least one of processed and stored by the one or more modules. Further, the system may also include a health care interface for providing at least one health assistant access to data at least one of processed and stored by the one or more modules.

In another aspect of the invention, a health management service includes the following services. A health data transformation and routing service is provided for converting raw health data to at least one common format and routing the common format health data to one or more other services that at least one of process and store the common format health data. A health monitoring service is provided for receiving at least a portion of the common format health data, processing the received data, and providing one or more notifications based on processing results. A health analytics service is provided for receiving data from one or more other services and generating health knowledge based on the received data. A health data and knowledge storage service is provided for storing data from one or more other services. Each of the health data transformation and routing service, the health monitoring service, and the health analytics service include one or more application programming interfaces for use in at least one of adding and editing logic associated with the respective service.

In one or more embodiments, the one or more services may be instantiated as one or more Web services.

In yet another aspect of the invention, an apparatus for health management includes a memory, and one or more processors operatively coupled to the memory and configured to: convert raw health data to at least one common format; process the common format health data; provide one or more notifications based on processing results; analyze the processing results; generate health knowledge based on the analyzed results; store at least one of the raw health data, the common format health data, the processing results, the analyzed results, and the health knowledge; and provide one or more application programming interfaces for at least one of editing and adding logic for performing one or more other operations; wherein the memory and the one or more processors are implemented in accordance with a cloud computing architecture.

In a further aspect of the invention, a method for developing a health management application includes the following steps. A health data transformation and routing service is instantiated for the health management application, the health data transformation and routing service converting raw health data to at least one common format and routing the common format health data to one or more other services that at least one of process and store the common format health data. A health monitoring service is instantiated for the health management application, the health monitoring service receiving at least a portion of the common format health data, processing the received data, and providing one or more notifications based on processing results. A health analytics service is instantiated for the health management application, the health analytics service receiving data from one or more other services and generating health knowledge based on the received data. A health data and knowledge storage service is instantiated for the health management application, the health data and knowledge storage service storing data from one or more other services. Each of the health data transformation and routing service, the health monitoring service, and the health analytics service include one or more application programming interfaces for use in at least one of adding and editing logic associated with the respective service.

In one or more embodiments, the one or more application programming interfaces may be provided to instantiate the services. Further, a sense-predict-respond framework may be used to implement the services.

In yet a further aspect of the invention, an article of manufacture for providing a health management application includes a computer readable storage medium having tangibly embodied thereon computer readable program code which, when executed, causes a computer to perform the above-mentioned instantiation steps.

Advantageously, illustrative embodiments of the invention provide an open platform based on a software-as-a-service paradigm that enables developers to develop wellness management applications. In such an approach, the inventive platform provides services (application programming interfaces) that are used to develop wellness management applications. Furthermore, the system may be implemented in an elastic cloud architecture for scalable service provision and execution.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a wellness management system according to one embodiment of the invention.

FIG. 2 illustrates a methodology for developing a wellness management application according to one embodiment of the invention.

FIG. 3 illustrates a methodology for a sense stage of analytic development according to one embodiment of the invention.

FIG. 4 illustrates a methodology for a predict stage of analytic development according to one embodiment of the invention.

FIG. 5 illustrates a service development methodology according to one embodiment of the invention.

FIG. 6 illustrates an end user usage methodology according to one embodiment of the invention.

FIG. 7 illustrates a wellness monitoring service framework according to one embodiment of the invention.

FIG. 8 is a block diagram of a computing system for implementing one or more steps and/or components in accordance with one or more embodiments of the invention.

### DETAILED DESCRIPTION OF PREFERRED EMBODIMENTS

Principles of the present invention will be illustratively described herein in the context of wellness management applications and environments. It is to be appreciated, however, that the principles of the present invention are not limited to the illustrative wellness management applications and environments described herein. Rather, principles of the invention are directed broadly to techniques for developing health management applications and managing health issues associated with one or more individuals or subjects (entities). A “subject” or “entity” may be human or some other living organism. Further, a “wellness management application” is one or more software programs that are executable on one or more computing systems that assist users with health management.

As mentioned above, recent advances in personal wellness monitoring devices and living sensors have enabled wellness management applications to provide awareness on wellness status and treatment progress, generate alerts of potential risk, and make suggestions on how to maintain and improve healthy lifestyle. Specifically, these existing applications are developed based on collected information about vital signs (e.g., heart rate, blood pressure), nutrition, physical exercise, and living environments. It is considered as an efficient and low cost solution for improving healthcare quality. However, existing wellness management services/applications are not as popular as they should be, as there are some key weaknesses.

First, for example, most of the current solutions are device-oriented and personal computer (PC) based one-fits-all applications. As wellness management applications should be highly personalized, the one-fits-all paradigm usually can not satisfy the unique requirements of different users. For example, glucose monitoring should be different for Type I and Type II diabetes.

Also, these existing applications are tightly integrated with the provided devices. Such an application per device paradigm has imposed burdens on users to coordinate the many disintegrated/disconnected applications. It would be desirable for these applications to work collaboratively to provide comprehensive services for end users.

Further, these existing PC-based applications lack an open application programming interface (API) that can enable the development of more value added services.

However, it is realized that developing a platform for wellness management that overcomes the above and other drawbacks has its own challenges, as will be illustratively outlined below.

(1) Wellness data collection. There are various data sources from different kinds of devices/sensors for wellness management applications, which include device/personal identification, vital signs, nutrition, physical activity, living environments, etc. Even for the same type of devices, different vendors may adopt different data formats to represent the measurement. Therefore, a unified ontology framework is desirable so that data in different formats can be transformed in a unified format and semantics. Another issue is about data collection. Data from various devices/sensors or media (e.g., data feed from the World Wide Web or simply “Web”) are collected with different collection policies. For example, when collecting data from vital sign monitoring devices, i.e., blood pressure, some clinical guidelines need to be followed, in order to guarantee the data quality. It is desirable for the platform to facilitate the data collection process (e.g., data format/semantics transformation), so that data can be used by different applications/services.

(2) Real-time wellness monitoring. Providing wellness awareness for users is a key issue, as it can give end users incentives to continue using the wellness management applications. For example, when wellness measure data are uploaded, certain feedbacks about the user's wellness status should be provided. Technically, it is an event processing problem, with each data collection session considered as an event occurrence. Therefore, it would be desirable for the platform to provide a programming model that allows independent software vendors (ISVs) to specify and execute the event processing logic. The term “logic” is generally defined as any operation(s) and/or mechanism(s) (e.g., software, hardware, combinations thereof, and the like) for performing one or more functions or tasks. Once the event processing logic is deployed, how to efficiently execute them is a challenge, given the fact that overall volume of events can be very high with the number of users increasing. Further, the event processing logics are highly dynamic, as the monitored subject's activity and status are very dynamic. Therefore, dynamicity support is a key issue for successful wellness monitoring.

(3) Analytics for wellness compliance and progress. With the collection of wellness data and results from real-time event processing, the platform can accumulate a very rich data set for analytics to generate wellness evidences. Here, “evidence” refers to evidence-based medicine (EBM) or evidence-based practice (EBP) which aim to apply the best available evidence gained from the scientific method to the clinical decision making process. The generated evidences can be either used in real-time monitoring as new event processing logic, or provided as suggestions for end users to change their lifestyles for better wellness. In this aspect, it would be desirable for the platform to provide tools that allow ISVs to specify and execute Extraction-Transform-Load (ETL) logic and to define evidence mining tasks. Also, given the fact that data is stored in distributed locations, a scale-out solution would be desirable. Furthermore, the platform also should provide mechanisms to use evidences generated. It should be noted that when the end-users' data are used for analytics, appropriate access control is desirable for protecting the privacy of end users.

In accordance with principles of the invention, an open wellness management system is provided for addressing the above and other challenges. Some of the main features of such an inventive system are as follows.

(1) Open platform for system as a service. In illustrative embodiments, we adopt a software-as-a-service paradigm that enables ISVs to develop wellness management applications. In such an approach, the inventive platform provides services (APIs) that are used to develop wellness management applications.

To enable an open platform, in one embodiment, we adopt Web services (i.e., RESTful API) to provision the wellness management functionalities. In general, World

Wide Web Consortium (W3C) sets the standards and specifications on Web services, for example, the Web service architecture is given at the W3C website (w3.org) in document “W3C Working Group Note 11 Feb. 2004,” the disclosure of which is incorporated by reference herein.

As is known, a RESTful web service (also called a RESTful web API) is a simple web service implemented using HTTP (HyperText Transfer Protocol) and the principles of REST (Representational State Transfer). It is a collection of resources, typically with three defined aspects: (i) the base URI (uniform resource identifier) for the web service, such as http://example.com/resources/; (ii) the MIME (Multipurpose Internet Mail Extensions) type of the data supported by the web service; and (iii) the set of operations supported by the web service using HTTP methods (e.g., POST, GET, PUT or DELETE). In general, REST is a style of software architecture for distributed hypermedia systems such as the World Wide Web. Conforming to the REST constraints is referred to as being ‘RESTful.’

By way of example, in one embodiment, we provide four categories of services for supporting most wellness management scenarios, these service categories include: (i) a data transformation and routing service that facilitates information flow on the platform; (ii) a wellness monitor service that processes information in real-time fashion; (iii) wellness analytics that provide deeper understanding on people's wellness; and (iv) a personal wellness record and knowledge repository that persists wellness information and provides information access APIs.

(2) Elastic cloud architecture for scalable service provision and execution. It is realized that supporting ISVs to develop new wellness management applications on this platform results in a very dynamic workload. Also, the different services come with different workload requirements. For example, the workload of data transformation and routing services is dependent on the number of users and associated devices and the frequency of data collection. While for wellness monitor services, workload is mainly dependent on event volume and complexity of the event processing logic. These two services consume resources of network bandwidth, memory and central processing unit (CPU) and impose a real-time processing requirement. The wellness analytics services consume additional input/output (I/O) and storage and may not always operate in real-time. Accordingly, in one embodiment, we adopt an elastic cloud architecture to address the scalability and dynamic workload issues.

As is known, a phrases “cloud architecture” or “cloud computing” are typically defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction, see, Cloud Computing Definition, National Institute of Standards and Technology, Version 15, October 2009, the disclosure of which is incorporated by reference herein. However, it is to be understood that principles of the invention are not intended to be limited to this particular definition of cloud computing, and that other suitable computing environments are contemplated as being within the scope of the invention.

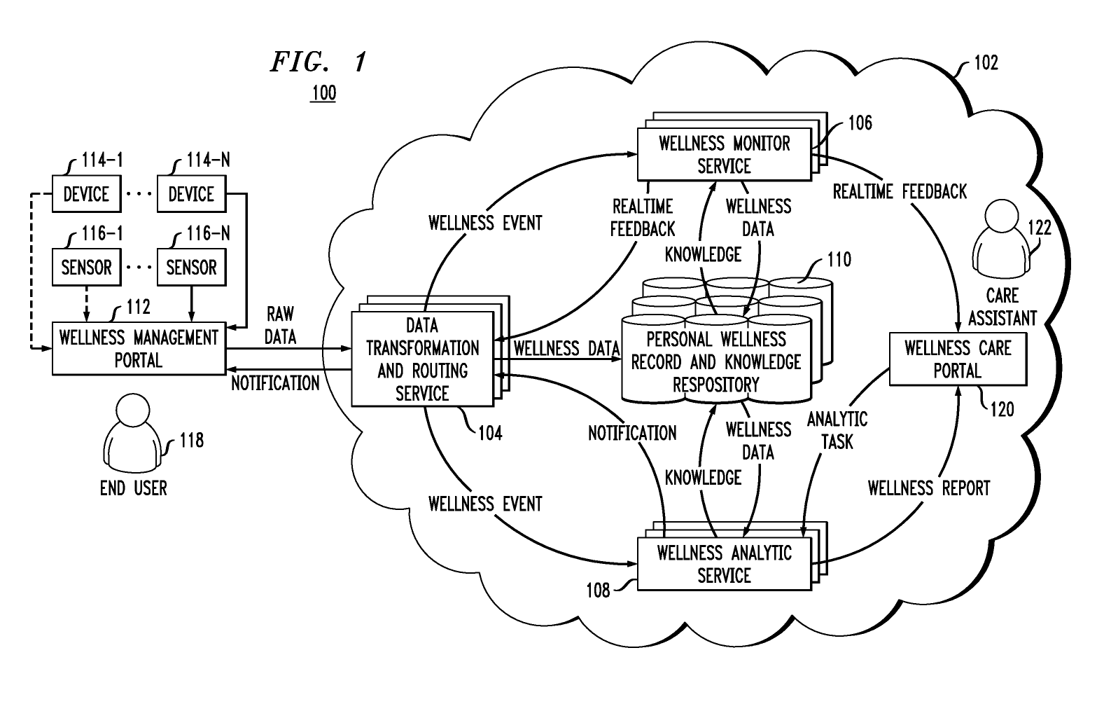

FIG. 1 illustrates a wellness management system 100 according to one embodiment of the invention. As shown, the system 100 has four main components, namely: (i) a data transformation and routing service 104; (ii) a wellness monitor service 106; (iii) a wellness analytic service 108; and (iv) a wellness record and knowledge repository 110. In this embodiment, it is assumed that these components are built on top of a cloud infrastructure 102. That is, the components are hosted on a cloud architecture or cloud computing system, as illustratively described above. In such a case, it is understood that computing resources of the cloud architecture (e.g., servers, storage, networks) are provisioned and deployed to implement each of the data transformation and routing service 104, the wellness monitor service 106, the wellness analytic service 108, and the wellness record and knowledge repository 110.

As shown, the wellness management system 100 also includes two kinds of portals essential to personal wellness, namely: (i) wellness management portal 112 that connects with health monitoring devices (114-1 . . . 114-N) and health monitoring sensors (116-1 . . . 116-N) and provides end user(s) 118 wellness services based on the collected data, and (ii) wellness care portal 122 for care assistant(s) 122. It should be noted that one or more wellness management portals 112 can be deployed on either PCs or smart phones. It is also to be noted that, while one wellness management portal 112 and one end user 118 is shown, there may be a plurality of such portals and end users that are connected to the system 100. The same is true for the wellness care portal 120 and care assistant 122, i.e., there may be a plurality of such portals and care assistants that are connected to the system.

In accordance with illustrative embodiments and continued reference to FIG. 1, we now explain information flow, present wellness application development cycle, and explain how wellness management is realized, using an illustrative scenario.

The wellness management system 100 supports two kinds of information flows, namely, event flow and data flow. As shown in FIG. 1, devices (114) and sensors (116) are connected to an information gateway upon which wellness management portals 112 execute. That is, as mentioned above, the wellness management portals may be executed on smartphones or other computing devices associated with an end user. When end users are using wellness services, data are collected from the sensors/devices following pre-specified data collection policies.

Data collection policies are formulated as event condition action (ECA) rules in one embodiment of the system. An event can be a time-base triggered event, e.g., an event that occurs every day at 10 o'clock, or every 5 minutes for a week. Such events usually are used to collect vital signs data. An event can be a life activity event, e.g., before/after every meal. Such events usually are used to initiate vital signs collection that is driven by clinical guidelines. For example, to trace the wellness status of a diabetic patient, it is import to record the glucose level before and after a meal. An event can be event triggered by measurement results of vital signs. Such events are used to trigger follow-up measures when abnormal vital signs are detected.

For example, when blood pressure measurements indicate hypertension, electrocardiogram (ECG) measurements may be required. Combined with user identifiers, all collected data is considered as raw data (which may be encrypted for privacy/security concerns) that would be sent to the data transformation and routing service 104.

When the data transformation and routing service 104 receives raw data, it transforms the information into a common (preferably, standard) format with semantics annotation. In one embodiment, the data transformation and routing service 104 adopts Continua (Continua Health Alliance, http://www.continuaalliance.org/) as the target transformation format to which the raw data is to conform. Further, the service 104 determinates whether an event should be generated and routed to the wellness monitor service 106 for further processing. After the monitor service 106 processes the event, a real-time feedback can be generated for related end users. Further, a wellness event can be used by the wellness analytic service 108 for prediction scoring. Such an information flow, as is depicted between the various components of FIG. 1, is considered as the event flow.

Meanwhile, the routing service forwards the wellness data to the wellness record and knowledge repository 110 for later access. Integrated with other data sources such as previous personal health records, the accumulated wellness data can then lend support to wellness evidence mining as parts of the wellness analytics service 108. Eventually, the new wellness knowledge will be delivered to end users. This is considered as the data flow of the system, as is also depicted between the various components of FIG. 1.

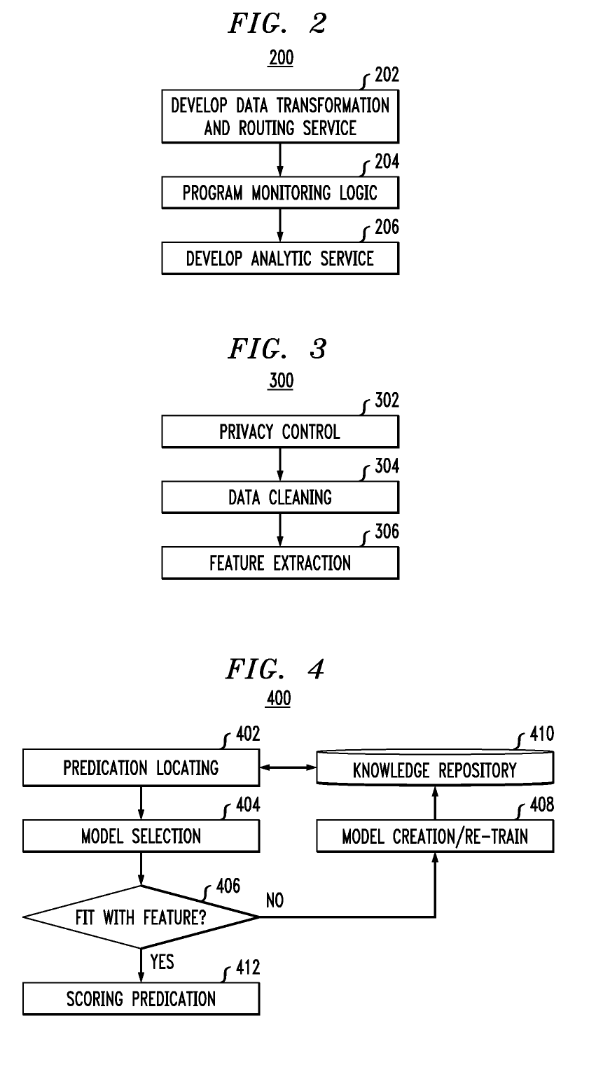

We now describe a service development cycle. In one embodiment, the wellness management system 100 provides open APIs that allow ISVs to develop new wellness management applications. A typical wellness application comprises data transformation and routing services, wellness monitor services and wellness analytic services. Therefore, developing new applications includes three aspects of effort which will now be described below in the context of FIG. 2.

FIG. 2 illustrates a methodology 200 for developing a wellness management application according to one embodiment of the invention. As shown, the methodology 200 comprises three main steps.

In step 202, the data transformation and routing service is developed. It is realized that the first step to develop a new wellness management service is identifying related data sources. If new devices (114)/sensors (116) are required, the developer can customize the data transformation services to transform the raw data from standardized format. Further, the developer needs to model the data collection policies and deploy them as part of the wellness management application(s) being developed. The policy specifies when and how the data should be collected. For example, a data collection policy for collecting blood glucose levels should be measured before and after every meal. It should be noted that developers also need to decide whether collected raw data need to be processed in a real-time fashion or not.

Therefore, the APIs that enable developing new data format transformation and routing logic include:

(i) Register (CDATemplate cdaTemplate), where CDADocument is an XML (Extensible markup Language) document template in CDA format. CDA refers to the Clinical Document Architecture and is defined in the standards documents referred to as CDA Release 2.0, the disclosure of which is incorporated by reference herein in its entirety. The CDA standard is developed and maintained by Health Level 7 International (H17) which is a Standards Developing Organization operating in the healthcare arena.

(ii) Transfor(XMLDoc xmlDoc, CDATemplate cdaTemplate, Mapping mapping), where XMLDoc is in the raw data format, while Mapping contains a collection of xpath expression 3-tuple <XPATHExpression[] xmlDocXpathExpressions, XPATHExpression cdaTepmlateXpathExpression, FunctionExpression, functionExpression>, which indicate cdaTemplateXpathExprssion =functionExpression(xmlDocXpathExpressions), see, e.g., XML Path (XPath) Language, Version 1.0, W3C Recommendation 16 Nov. 1999, the disclosure of which is incorporated by reference herein in its entirety.

(iii) publication(CDADocument cdaDocument, Boolean isEvent), which publishes the CDA document, and indicates whether it is event data or not.

In case when real-time monitoring is necessary, event instances are generated and routed to the wellness monitoring services 106.

In step 204, monitoring logic is programmed. Such programming is accomplished by the system 100 providing APIs that allow developers to:

(i) Subscribe the related events, wherein API is defined as Subscribe(Event event) in one embodiment. Event is an event type definition that specifies the data format of the event, it can be considered as a Class in a UML (Unified Modeling Language) diagram.

(ii) Filter un-interested events, wherein API is defined as Filter(Event event, FilterPredicate predicate) in one embodiment. FilterPredicate is a Boolean expression that exams the properties of the event instance. It should be noted that the Boolean expression can be a compound expression that is constructed by Boolean operators AND, OR, NOT, etc.

(iii) Correlate events to associated monitoring entities. In one embodiment of the system, “monitor context” is used to represent monitor entities, i.e., the wellness status of end users. A monitor context instance is identified by a unique user identifier (ID) and persisted in a personal wellness record. In one embodiment, the correlation relationship API can be defined as Correlation(Event event, MonitorContext monitorContext, CorrelationPredicate predicate), wherein CorrelationPredicate specifies the relationship among the event instance and monitor context instance, it is a match expression that match the monitor context instance with the event instance.

(iv) Update the monitored status of entities, wherein API is defined as Assign( MonitorContextExpression expression, Function function, Parameter[] parameters), in one embodiment. The expression specifies the property in a monitor context instance, the function specifies the computation logic, and parameters are the input for the functions.

(v) Generate and delivery alerts, wherein API is specified as Alert(AlertCondition condition, AlertEvent alertEvent, AlertEventExpression[] alertEventExpression) in one embodiment. The alert condition specifies the situation when alert is generated, wherein the condition is a Boolean expression that exams the properties of a monitor context instance. AlertEvent defines the event format of the event, and AlertEventExpression is a collection of expressions that computes the value of properties in alert event.

It should be noted that event processing logic is highly dynamic, due to the adjustment of the treatment plan and wellness goal and the dynamicity of wellness services.

In step 206, the wellness analytic service is developed. That is, the third step to developing a wellness management application is creating analytics services. The system 100 provides an API for healthcare applications to: (i) integrate heterogeneous data source (sense) wherein, in one embodiment, the API can be specified by AddDataSource(XMLDoc xmlDoc, URI uri), AddDataSource(Table table, URI uri) where both XML (Extensible Markup Language) documents and relational table can be considered as new data source, and uri provides an access approach for the data source; (ii) create/update prediction model wherein, in one embodiment, the API can be specified as CreateModel(PMMLModel pmmlModel), the PMMLModel (where PMML is the Predictive Model Markup Language Version 4.0, the disclosure of which is incorporated by reference herein, available from the Data Mining Group) specifies the prediction creation/update task; (iii) draw predictions by applying or extending models in a repository (predict) wherein, in one embodiment, the API can be specified as Prediction(PMMLModel pmmlModel), PMMLModel specifies the prediction model and scoring task, and (iv) trigger proper responses (respond), Response(Action action), where in action can be sending out emails, SMS message, etc. A main goal is to enable any ISV to use the API and the sense-predict-respond framework to implement their services and exchange information with third party applications.

In the sense stage of analytic development, a developer first creates a template that records steps needed for generating features from selected data sources. In particular, as shown in methodology 300 of FIG. 3, the template calls functions from an API to perform three main tasks: privacy control 302, data cleaning 304, and feature extraction 306.

Privacy control functions 302 verify whether a user can access all the requested data fields by invoking policies which determine who have the authority to access what part of the data and what combination of the data fields should never be accessed together. Data cleaning functions 304 maintain rules of handling missing values, and data that are uncertain and inconsistent. Feature extraction functions 306 specify how to recognize semantic entities and their syntactic links from unstructured information (such as clinical notes) and how to transform the extracted information into standardized features.

In the predict stage, as illustrated in methodology 400 of FIG. 4, a developer locates a model repository 402, identifies models needed for meeting the requirement of the analytic application, selects 404 a model from knowledge repository 110 (FIG. 1), and performs analysis 406 on target patient's feature set. If the model can not fit with the feature set, the developer applies the create function 408 to train a new model, using a modeling method and the feature set specified in a given modeling schema that is selected. Also, if the selected model needs to be adapted with new data, such as recent history of the target patient, the developer applies the update function 408 to retrain the model, using the specified method and feature set. To enforce compatibility and exchangeability, all the models in the repository are stored 410 and extended in compliance with the same standard, e.g., in one embodiment, the Predictive Model Markup Language (PMML). Note that if the model fits with the feature set, the prediction is scored 412.

Finally, in the respond stage, the developer specifies the event-condition-action (ECA) rules to regulate the connection between the prediction results from the predict stage, e.g., the safe threshold of glucose concentration learned from previous records, and the action items, e.g., updating the monitoring logic with the safe threshold that was found.

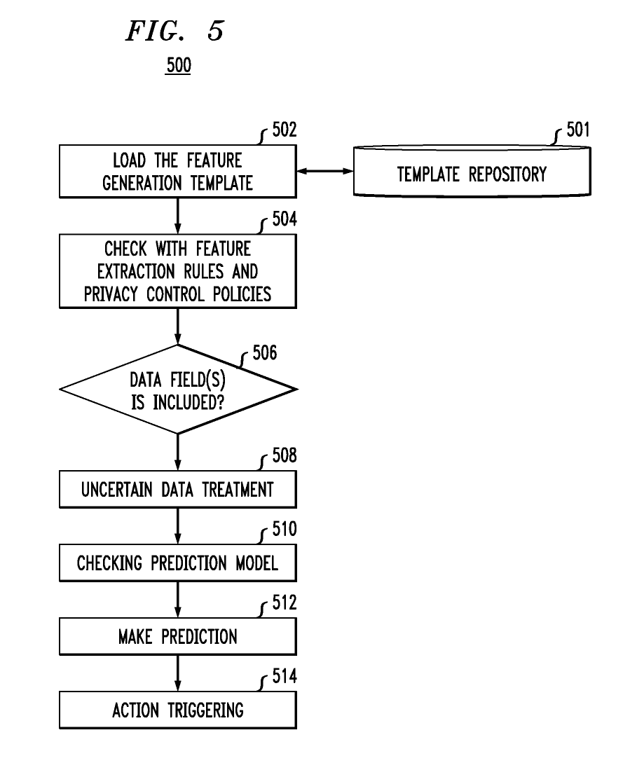

At run time, as illustrated in methodology 500 of FIG. 5, the working system loads the feature generation template (502) from template repository 501. The system first checks (504) with the feature extraction rules and privacy control policies to determine which data fields to be included in an integrated view (506). Then, the system treats uncertain data fields (508) in the integrated view with the pre-specified data cleaning procedure, transforms the integrated view into a feature set using the specified extraction rules, and finally loads the feature set into memory.

Before entering the prediction stage, the system will check whether the selected model exists or needs update (510). If a new model is required for prediction, it will be trained according to what is specified in the modeling schema. In the prediction stage, the loaded feature set will be validated against the selected model and make the prediction (512). Given the prediction result, the system will determine the event and conditions and apply the ECA rules to trigger the right action in the response stage (514).

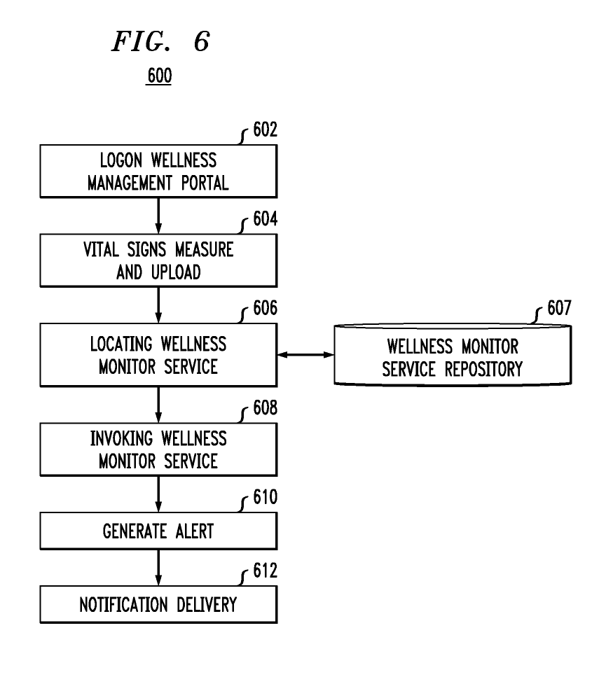

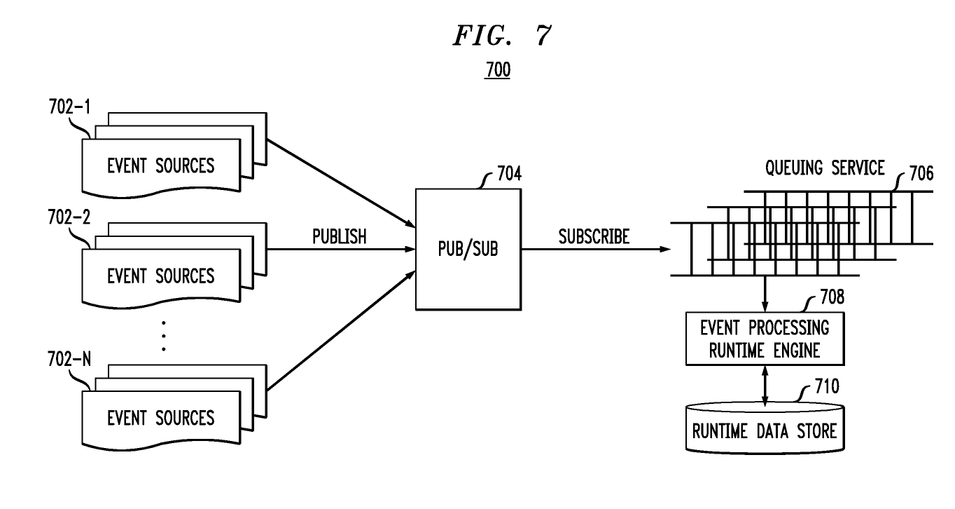

Now we explain an illustrative end user usage scenario in the context of FIG. 6. When an end user 118 (FIG. 1) logs onto (602) the wellness management portal 112 (FIG. 1), the portal may remind the user to measure (604) some vital signs. When the user initiates the process, the related service will apply the clinical guideline for vital signs measurement. When data are uploaded (604), the collected data are consumed by the wellness monitor service 106 (FIG. 1).

The system first locates (606) the wellness monitor service from a wellness monitor service repository (607), and then invokes the service (608). By executing the event processing logic, the monitor service 106 examines the new received data with historic data to provide real-time feedback. The feedback can be an alert (610) for the user to be aware of an out of range vital sign measurement result. In certain cases, one or more notifications may be generated and delivered (612) to wellness assistants 122 (FIG. 1) for further investigation. The collected data and processing results are persisted in the wellness record and knowledge repository 110 (FIG. 1).

We now describe in detail one embodiment of a wellness monitor service (e.g., module 106 in FIG. 1). It is realized that current, real-time wellness monitoring focuses on treatment compliance management, for example, chronic disease care. Chronic disease treatment includes clinical and home care. Home care is very important during the treatment, wherein most of the medical procedures are performed. However, currently, there are not sufficient services that can facilitate home care. On the one hand, the end users lack awareness on how well they adhere to treatment plans. Further, doctors either lack information or decision support tools to understand the effectiveness of home care. Principles of the invention thus provide a solution that allows ISVs to develop new wellness monitor services that are able to provide better awareness.

Typically, monitoring of home care for end users focuses on vital signs, physical exercise, nutrition, etc. Due to the diversity of people's wellness conditions, such as mobility, cardiac performance, and nutrition habits, the monitoring service requires personalization. Further, human's activities and wellness progress are dynamic. End users may switch to different wellness services, or adopt new devices, etc. Also, the doctor may change treatment plans, according to progress of a patient's wellness recovery. This requires monitor services to support dynamicity as part of the non-functional requirements. Given the fact that the number of monitor services and end users may scale up, the system needs to deal with scalability issues.

Accordingly, in one embodiment of the system, we introduce a cloud-based wellness monitoring service framework. The framework provides a monitor service development API for developing event processing logic for realtime feedback. The scope of the API is given above. The framework also provides a service management API for managing the dynamicity of the application logic. The API enables runtime evolution of event processing logic. The dynamicity of the application logic may include: (a) change of event subscription and associated filtering predicates; (b) modification of metric definition and associated computation logics; and (c) adjustment of alert generation logic.

The framework also provides an elastic service run time architecture. In one embodiment, as mentioned above, we provide a cloud-based infrastructure for hosting the monitoring services developed by ISVs. The illustrative infrastructure for a wellness monitoring service framework 700 is shown in FIG. 7. As shown, the framework includes a plurality of event sources 702-1, 702-2, . . . 702-N, a publish/subscribe service 704 and a queue service 706 for message transportation, a run time engine 708 for executing event processing logic, and a run time data store 710 for persistence. It should be noted that the publish/subscribe and queue services, the run time engine, and the run time data store are based on a self-management platform-as-a-service, i.e., they can automatically scale-out/in according to the workload. As is evident from the infrastructure shown in FIG. 7, the plurality of event sources 702 publish events to the publish/subscribe service 704. In accordance with the queuing service 706, one or more events of the events are provided to the event processing engine 708 which performs the specific functions that the developer programmed the engine to perform. Raw and processed data may be stored in data store 710.

We now describe in detail one embodiment of a wellness analytics service (e.g., module 108 in FIG. 1). It is realized that central to the development of a wellness management application is the analytic capability to transform wellness monitoring data into actionable insights. Below, we use the scenarios of diabetic care to demonstrate the use of analytics and the associated challenges. In particular, we focus on three areas: disease management, lifestyle management, and disease learning. We explain their respective challenges as well as a wellness analytic service, developed and deployed according to one or more embodiments of the invention, which addresses these and other challenges.

(i) Disease Management. In the first scenario, it is realized that the process of transforming monitoring data into tailored feedbacks involves four major analytics tasks: (1) predict glucose concentration ahead-of-time; (2) determine abnormal glycemic episodes; (3) regulate insulin delivery; and (4) generate personalized management plans. To address these tasks, models are crafted that describe the characteristics of the target phenomenon such that the models can be used to validate the conformity of incoming data for detection or ahead-of-time-prediction. For example, the monitor service determines safe thresholds for glucose concentration and identifies predictors of hyperglycemia and hypoglycemia episodes. A closed loop insulin delivery system also has prediction models to determine optimal insulin delivery rates.

Despite the success of the physiology-based and data-driven modeling approaches in experimental settings, there still exist challenges in employing them to create analytics services. First, the creation of physiology-based compartmental models can be hindered by insufficient knowledge of the compartments, e.g., the structure and dynamics of the insulin hormone. Inter- and intra-patient variability, which has been found in previous research as significant, has to be addressed each time the models are applied. Second, the data-driven models also have to account for inter- and intra-patient variability before drawing predictions on the targeted patient. Moreover, the continuous glucose monitoring (CGM) scenario poses a new real-time analysis requirement to existing temporal modeling techniques.

There are several technical questions and research issues to be addressed for the development of diabetes management service. These issues include how to compensate for the uncertainty between the proposed models and targeted patients and, if necessary, how to adapt models for the patients. Specific to the CGM scenario, there are also issues about how to adapt the temporal models for the targeted patient and compute them efficiently. Lastly, since both the physiological and data-driven modeling approaches have shown potential in disease management, we can develop new approaches that integrate prior knowledge of the physiological model into the data-driven one.

(ii) Lifestyle Management. Previous studies have shown the effectiveness of lifestyle interventions in diabetes prevention and management. However, computer-assisted programs have not fully leveraged the awareness of the patient's health conditions obtained by monitor services. For example, depending on the current glucose concentration, different types of diet plans and physical exercises can be proposed to the target patient to optimize glycemic control. Also, if the monitor service comes with the capability to recognize dietary intakes (e.g., by note-taking or smart object recognition device) and physical exercise (e.g., by notes or by sensors), the information can also serve as pre-conditions for optimization.

We have thus realized that the task of lifestyle intervention planning is an optimization problem such as, for example, multi-attribute optimization and multi-attribute decision making frameworks. To apply these frameworks, we specify the knowledge of monitoring data and personal lifestyle history as optimization constraints. In addition, we also infer user models of the target patients based on their preferences and use the user models to adapt their lifestyle intervention plans.

(iii) Disease Learning. Monitoring data collected for disease and lifestyle management can also be accumulated to generate evidence for clinical decision support and disease learning. In general, there are at least three types of predictive diagnostic decisions: (1) prediction of the risk of developing diabetes; (2) early diagnosis of diabetes and (3) prediction disease progression and related complications, e.g., cardiovascular diseases. Among these clinical decisions, (2) and (3) are the most promising to be enhanced with additional information from the monitoring data. First, the monitoring data of the key glycemic control players (e.g., fasting plasma glucose, fasting serum insulin) are collected and stored in the database. Then, the analytics component can perform predictive diagnosis on disease progression and complications, leveraging the physiological models of the key players.

Given the high risk of diabetes as well as individual predisposition to target organ injury, such disease learning and predictive diagnostics applications are developed to support clinical decisions on pre- and diabetes care. While properties of the likely disease evolution path may be quantified with physiology-based analytics models, there still exists a challenge to apply these models in practice. Accordingly, principles of the invention provide solutions for using the collected personal data to make accurate prediction of disease progression and complications on the individual level for clinical decision support. As for the research of disease learning, principles of the invention provide solutions for finding similar patients from the pool of accumulated monitoring data. Automatic (or semi-supervised) clustering can be used to identify a sub-population that has distinctive sensitivity to certain external factors and a propensity to certain complications.

As explained in detail above, analytic services according to the invention provide programming models and related APIs, testing/debugging data set, and runtime environment that facilities ISVs to develop new applications for the above three areas. It should be noted that knowledge generated by the analytic applications can be deployed as event processing logic, in order to provide end users deeper awareness of wellness status in real-time fashion.

Advantageously, as has been illustratively explained herein, we have identified gaps between existing solutions and successful adoption of wellness management applications including: (1) a lack of understanding to the past (e.g., medical records, lifestyle patterns); (2) a lack of understanding to the current context (e.g., self-motivation, how is a patient now, where the patient is, who the patient knows, preferred feedback mechanism in current context, etc.); and (3) a lack of understanding to the changes in context (e.g., changes in how the patient is, where the patient is, and who the patient knows).

To address these and other gaps, we have provided a set of pivotal features including: (1) a platform that is equipped with connections to personal wellness record (PWR) databases and analytics capabilities of bootstrapping the processing of personal wellness risk profiling from examples, saving users from the high entry barrier of manual input; (2) a context-awareness component that integrates contextual information, which are collected from smart sensors (e.g., activity type, location, social network status) and users in the loop, to infer personal wellness status (i.e., how the patient is); (3) a personalized continuous feedback loop mechanism that can update the current status and recommended services with respect to changes revealed in the monitoring context.

There are many suitable illustrative implementations based on a combination of these pivotal features. For example, a health meter can be provided to aggregate information from PWRs to perform health risk assessment and gauge the risk reduction level given recent monitoring data. Thus, we provide platform support and open APIs that have taken into account the issue of reusability, composibility, and accessibility.

Accordingly, as explained herein, illustrative embodiments provide an event-driven platform for wellness service. Event flow is considered as key information flow in wellness service system. First, all the information collected from devices and sensors are considered as event for real-time processing. Second, event sequences are used to construct context information for analytics. In particular, this context information is not only used to create analytic model (e.g., prediction model), but also used to score analytic result for personalizing wellness services. Third, the platform provides APIs allowing developers to develop new data transformation and routing logic, event processing logic, and analytic logic.

Illustrative embodiments also provide service composition for wellness services and solutions. Service composition mechanisms are provided for creating new wellness services. Further, the mechanisms also enable composing multiple wellness services to create new collaborative care solution.

Illustrative embodiments also provide service management mechanisms for a wellness system. The platform not only provides mechanisms to develop new services/solutions, but also provides management mechanism for a service system, which includes service deployment, service repository and registry, service brokering, etc.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-7, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-7, can also include, as described herein, providing a system, wherein the system includes distinct modules (e.g., modules comprising software, hardware or software and hardware). By way of example only, the modules may include, but are not limited to, a data transformation and routing service module, a wellness monitor service module, a wellness analytic service module, a wellness record and knowledge repository module, a wellness management portal module, and a wellness care portal module. These and other modules may be configured, for example, to perform the steps described and illustrated in the context of FIGS. 1-7.

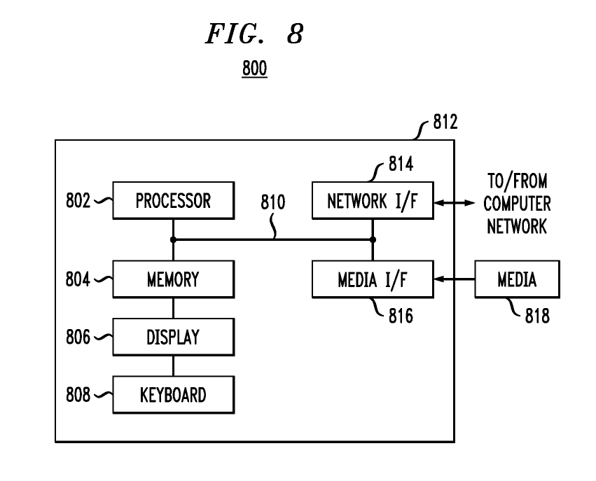

One or more embodiments can make use of software running on one or more general purpose computers or workstations. An example of one such computing system architecture is shown in FIG. 8. It is to be understood that the computing system architecture in FIG. 8 may represent one or more of the computing resources that are available in a cloud computing architecture, as described above. Also, the computing system architecture in FIG. 8 may represent one or more computing devices that are used by end users, developers, and/or wellness assistants to access and interact with APIs and other interfaces of the wellness management system described herein.

With reference to FIG. 8, such an implementation 800 employs, for example, a processor 802, a memory 804, and an input/output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer).

The processor 802, memory 804, and input/output interface such as display 806 and keyboard 808 can be interconnected, for example, via bus 810 as part of a data processing unit 812. Suitable interconnections, for example, via bus 810, can also be provided to a network interface 814, such as a network card, which can be provided to interface with a computer network, and to a media interface 816, such as a diskette or CD-ROM drive, which can be provided to interface with media 818.

A data processing system suitable for storing and/or executing program code can include at least one processor 802 coupled directly or indirectly to memory elements 804 through a system bus 810. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 808, display 806, pointing device, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 812 as shown in FIG. 8) running a server program. It will be understood that such a physical server may or may not include a display and keyboard.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A health management system, comprising:
a health data transformation and routing module, the health data transformation and routing module converting raw health data to at least one common format and routing the common format health data to one or more other modules that at least one of process and store the common format health data, the health data transformation and routing module comprising one or more application programming interfaces for use in at least one of adding and editing logic associated with the health data transformation and routing module;
a health monitoring module, the health monitoring module receiving at least a portion of the common format health data, processing the received data, and providing one or more notifications based on processing results, the health monitoring module comprising one or more application programming interfaces for use in at least one of adding and editing logic associated with the health monitoring module;
a health analytics module, the health analytics module receiving data from one or more other modules and generating health knowledge based on the received data, the health analytics module comprising one or more application programming interfaces for use in at least one of adding and editing logic associated with the health analytics module; and
a health data and knowledge storage module, the health data and knowledge storage module storing data from one or more other modules.

2. The system of claim 1, further comprising a health management interface, the health management interface providing at least one end user access to data at least one of processed and stored by the one or more modules.

3. The system of claim 2, further comprising one or more sensors and devices coupled to the health management interface, wherein the one or more sensors and devices collect the raw health data such that the raw health data can be sent to the data transformation and routing module.

4. The system of claim 1, further comprising a health care interface, the health care interface providing at least one health assistant access to data at least one of processed and stored by the one or more modules.

5. The system of claim 1, wherein the one or more application programming interfaces of the health data transformation and routing module are further configured for use in developing one or more services performed by the health data transformation and routing module.

6. The system of claim 1, wherein the one or more application programming interfaces of the health monitoring module are further configured for use in developing one or more services performed by the health monitoring module.

7. The system of claim 1, wherein the one or more application programming interfaces of the health analytics module are further configured for use in developing one or more services performed by the health analytics module.

8. The system of claim 1, further comprising one or more application programming interfaces for use in at least one of editing and adding logic, and developing one or more services performed by the health data and knowledge storage module.

9. The system of claim 1, wherein the health monitoring module comprises an event processing engine wherein at least a portion of the data received by the health monitoring module represents events.

10. The system of claim 9, wherein the event processing engine receives events from a plurality of event sources through at least one of a publish/subscribe service and an event queuing service.

11. The system of claim 1, wherein the health analytics module receives data from the health monitoring module and generates health evidence results.

12. The system of claim 11, wherein the health evidence results are usable to at least one of edit and newly create a service to be performed by one or more of the modules.

13. The system of claim 11, wherein the health evidence results are usable to provide a suggestion to an end user to alter their lifestyle for increased wellness.

14. The system of claim 1, wherein one or more of the modules are implemented in accordance with a cloud computing architecture.

15. A health management service, comprising:
a health data transformation and routing service, the health data transformation and routing service converting raw health data to at least one common format and routing the common format health data to one or more other services that at least one of process and store the common format health data, the health data transformation and routing service providing one or more application programming interfaces for use in at least one of adding and editing logic associated with the health data transformation and routing service;
a health monitoring service, the health monitoring service receiving at least a portion of the common format health data, processing the received data, and providing one or more notifications based on processing results, the health monitoring service comprising one or more application programming interfaces for use in at least one of adding and editing logic associated with the health monitoring service;
a health analytics service, the health analytics service receiving data from one or more other services and generating health knowledge based on the received data, the health analytics service comprising one or more application programming interfaces for use in at least one of adding and editing logic associated with the health analytics service; and
a health data and knowledge storage service, the health data and knowledge storage service storing data from one or more other services.

16. The service of claim 15, wherein the one or more services are instantiated as one or more Web services.

17. An apparatus for health management, comprising:
a memory; and
one or more processors operatively coupled to the memory and configured to:
convert raw health data to at least one common format;
process the common format health data;
provide one or more notifications based on processing results;
analyze the processing results;
generate health knowledge based on the analyzed results; and
store at least one of the raw health data, the common format health data, the processing results, the analyzed results, and the health knowledge; and
provide one or more application programming interfaces for at least one of editing and adding logic for performing one or more other operations;
wherein the memory and the one or more processors are implemented in accordance with a cloud computing architecture.

18. A method for developing a health management application, comprising:
instantiating a health data transformation and routing service for the health management application, the health data transformation and routing service converting raw health data to at least one common format and routing the common format health data to one or more other services that at least one of process and store the common format health data, the health data transformation and routing service providing one or more application programming interfaces for use in at least one of adding and editing logic associated with the health data transformation and routing service;
instantiating a health monitoring service for the health management application, the health monitoring service receiving at least a portion of the common format health data, processing the received data, and providing one or more notifications based on processing results, the health monitoring service comprising one or more application programming interfaces for use in at least one of adding and editing logic associated with the health monitoring service;
instantiating a health analytics service for the health management application, the health analytics service receiving data from one or more other services and generating health knowledge based on the received data, the health analytics service comprising one or more application programming interfaces for use in at least one of adding and editing logic associated with the health analytics service; and
instantiating a health data and knowledge storage service for the health management application, the health data and knowledge storage service storing data from one or more other services.

19. The method of claim 18, wherein the application programming interfaces are provided to instantiate the services.

20. The method of claim 19, wherein a sense-predict-respond framework is used to implement the services.

21. The method of claim 20, wherein the sense-predict-respond framework comprises a sense stage for performing a privacy control task, a data cleaning task, and a feature extraction task.

22. The method of claim 21, wherein the sense-predict-respond framework comprises a predict stage for selecting a prediction model.

23. The method of claim 22, wherein the sense-predict-respond framework comprises a respond stage for specifying event-condition-action rules to regulate a connection between the prediction model and action items resulting from execution of the prediction model.

24. The method of claim 18, further comprising:
instantiating a health management interface, the health management interface providing at least one end user access to data at least one of processed and stored by the one or more services; and
instantiating a health care interface, the health care interface providing at least one health assistant access to data at least one of processed and stored by the one or more services.

25. An article of manufacture for providing a health management application, the article of manufacture comprising a computer readable storage medium having tangibly embodied thereon computer readable program code which, when executed, causes a computer to:
instantiate a health data transformation and routing service for the health management application, the health data transformation and routing service converting raw health data to at least one common format and routing the common format health data to one or more other services that at least one of process and store the common format health data, the health data transformation and routing service providing one or more application programming interfaces for use in at least one of adding and editing logic associated with the health data transformation and routing service;
instantiate a health monitoring service for the health management application, the health monitoring service receiving at least a portion of the common format health data, processing the received data, and providing one or more notifications based on processing results, the health monitoring service comprising one or more application programming interfaces for use in at least one of adding and editing logic associated with the health monitoring service;
instantiate a health analytics service for the health management application, the health analytics service receiving data from one or more other services and generating health knowledge based on the received data, the health analytics service comprising one or more application programming interfaces for use in at least one of adding and editing logic associated with the health analytics service; and
instantiate a health data and knowledge storage service for the health management application, the health data and knowledge storage service storing data from one or more other services.
